(19) United States
(12) Patent Application Publication
(10) Pub. No.: US 2005/0010509 A1
(43) Pub. Date: Jan. 13, 2005

(54) Response management device providing statistical tracking of contacts

(76) Inventor: Russell Andrew Straub, Evergreen, CO (US)

Correspondence Address: Craig W. Barber, PO Box 16220, Golden, CO, 80402-6004, US

(21) Appl. No.: 10/771,275

(22) Filed: Feb. 2, 2004

Related U.S. Application Data
(63) Continuation-in-part of application No. 10/618,215, filed on Jul. 11, 2003.

(51) Int. Cl. G06F 17/60

(52) U.S. Cl. 705/35

(57) ABSTRACT

The present invention teaches that financial services, in particular mortgage lending/brokerage services may be offered on-line via a consumer contact management system which collects statistical data on the contact process and impels faster responses on the part of mortgage professional teams. In particular, when a consumer provides a contact to a financial team, the information provided is mediated by a central computer system/server/site and divided into specific contact information and general financial information. The central system then forwards the general financial information to the team but withholds the specific contact information until the professional responds, at which time specific contact information is provided. Statistics on response effectiveness, timeliness, comparative data, and raw numbers may be gathered and analyzed by this means.

### CROSS-REFERENCE TO RELATED APPLICATION

This application is a continuation-in-part of patent application Ser. No. 10/618215 filed Jul. 11^{th}, 2003, and entitled DEVICE AND METHOD FOR FINANCIAL SERVICES CONTACT MANAGEMENT in the name of the same inventor, Russell Straub.

### FIELD OF THE INVENTION

This invention relates generally to contact management software and specifically to management of contacts for financial services, and more specifically to a response management system capable of accurate statistical tracking and analysis of client contacts and agent responses.

### STATEMENT REGARDING FEDERALLY FUNDED RESEARCH

This invention was not made under contract with an agency of the US Government, nor by any agency of the US Government.

### BACKGROUND OF THE INVENTION

Increasingly, financial services are being offered on the Internet. One particular example of such service offerings is that of mortgage brokers and lenders whose rates and services may be found compared at various well known websites. In general, a consumer logs onto such a website, provides some information, and either automatically or manually attempts to contact mortgage lenders, makers, companies, or brokers.

However, while the automated portion of the system can be very prompt at providing information and feed back to the consumer, this system may lag when the human financial professional enters the picture. The financial professional may be very busy, may be irregular about checking E-mail, may have poor Internet access and so on. Thus in a large organization with many mortgage brokers, lenders, or other financial professionals, there may be certain individuals who are extremely efficient about answering their E-mail or other contacts from consumers and others who are less efficient. Tracking the performance of the group as a whole, and the individuals within the group, is thus a high priority.

In addition, it is important that the financial professionals be impelled to respond promptly when contacted.

Various method may be tried for offering of on-line financial services.

U.S. Pat. No. 6,428,526 issued Aug. 20, 2002 to Dykes et al for SYSTEM AND METHOD FOR TRANSMITTING AND PROCESSING LOAN DATA teaches an Internet based system in which brokers and correspondents may exchange information by means of a website. In communications between brokers and a server, some sort of file structure is used. It appears that this patent does not specifically mention a controlled usage of E-mail in which the broker must respond via server before receiving complete client information.

U.S. Pat. No. 6,405,181 issued Jun. 11, 2002 to Lent et al for METHOD AND APPARATUS FOR REAL TIME ON LINE CREDIT APPROVAL teaches use of a computer system to request and analyze FICO scores. The only area of potential relevance is FIG. 14, showing that the Internet may be used by the server to obtain client information. Thus this patent also does not mention the use of the server to require, manage and monitor broker communications.

U.S. Pat. No. 6,385,594 issued May 7, 2002 to Lebda et al for METHOD AND COMPUTER NETWORK FOR CO-ORDINATING A LOAN OVER THE INTERNET teaches that a central computer 100 may be used to control loan application data transmitted over the Internet, however, limiting contact data of potential clients so as to require prompt response by mortgage brokers is not mentioned.

U.S. Pat. No. 6,345,262 issued Feb. 5, 2002 to Madden for SYSTEM AND METHOD FOR IMPLEMENTING A MORTGAGE PLAN teaches an automated method for creation of a mortgage plan, and thus is of little relevance to the present invention.

U.S. Pat. No. 6,272,528 issued Aug. 7, 2001 to Cullen et al for COMPUTER METHOD FOR DELIVERY OF FINANCIAL SERVICES teaches the use of mobile client-side agents to deliver financial quotes and other information to users. There seems to be no intermediary between ‘contacts’ and brokers and thus few if any structural similarities with the present invention.

U.S. Pat. No. 5,995,947 issued Nov. 30, 1999 to Fraser et al for INTERACTIVE MORTGAGE AND LOAN INFORMATION AND REAL-TIME TRADING SYSTEM teaches another method similar to that of the '594 patent above, which method of trading mortgage application information utilizes a transaction server 110. However, there is no discussion of control of ‘contacts’ so as to impel prompt broker response.

U.S. Pat. No. 5,983,206 issued Nov. 9, 1999 to Oppenheimer for COMPUTER SYSTEM AND COMPUTER-IMPLEMENTED PROCESS FOR IMPLEMENTING A MORTGAGE PARTNERSHIP teaches another method similar to the '262 patent above, dealing with automated structuring of mortgage documents, and thus again having little structural or conceptual similarity to the present invention.

U.S. Pat. No. 5,940,812 issued Aug. 17, 1999 to Tengel et al for APPARATUS AND METHOD FOR AUTOMATICALLY MATCHING BEST AVAILABLE LOAN TO A POTENTIAL BORROWER VIA GLOBAL TELECOMMUNICATIONS NETWORK teaches a matching method allowing matching of consumers and lenders via the Internet, however, it deals with loan origination and sends complete consumer information and thus does not teach central features of the present invention in a manner similar to the '206 and '262 patents above.

U.S. Pat. No. 5,231,571 issued Jul. 27, 1993 to D'Agostino for PERSONAL FINANCIAL ASSISTANT COMPUTER METHOD teaches a network of computers in which one terminal is used by a consumer but controlled by a remote financial representative at a remote representative terminal. The structure of the method is very different from the structure of the present invention.

Such prior art systems theoretically allow the possibility to collect at least certain statistics from the consumers. For example, voluntary reporting may allow comparison of the terms of loan offers made to consumers: rate, term, costs and so on. Such voluntarily reported statistics are notoriously unreliable.

Such systems also lack a module reporting contact management statistics to the users.

It would be advantageous to mediate between the consumer and the professional at the first contact, both in order to impel faster response by the professional and in order to gather statistics regarding speed and efficiency of the professional.

### SUMMARY OF THE INVENTION

### General Summary

The present invention collects useful and accurate contact management statistics between teams of professionals by use of a system which does not make a direct contact between an interested consumer and a mortgage professional they contact. Instead, after viewing the website geared to consumers, the consumer fills out a form or sends an email or otherwise notifies the site/server/central computer system of interest in a given financial/mortgage/real estate professional team. Such teams may advantageously be single companies, but other types of teams may be used and analyzed: individuals, a group under a single supervisor, a branch, an office, combinations of these and other types of teams may all be used. The server emails the financial/real estate/mortgage professional team with an email which does NOT contain any contact information for the consumer; instead the email is actually a link to the server's website geared to professionals. Once there, the professional responds to the consumer and receives direct consumer contact information such as telephone number, email address, etc. This server-based system not only impels professionals to make a prompt first response in order to secure the contact information, it also allows supervisory personnel to keep statistics on professional response time, consumer behavior, etc. The degree of statistical data to be kept can be varied to suit conditions, and further may be selectively provided to such professional teams.

Thus, the present invention teaches that financial services, in particular mortgage lending/brokerage services may be offered on-line via a consumer contact management system which impels faster responses on the part of mortgage professional teams. In particular, when a consumer provides a contact to a financial professional, the information provided is mediated by a central computer system/server/site and divided into specific contact information (such as name, E-mail address, telephone number, etc) and general financial information (such as loan amount, purchase price, property value, credit history, age, income, etc). The central system then forwards the general financial information to the team but withholds the specific contact information until the professional responds (by way of the same system), at which time specific contact information is provided.

Because of this first step (discussed in more detail in the parent application to this one), it becomes possible to collect and report to the professional teams on real and true contact management statistics.

In particular, statistics relating not just to offer made but also to the management of the offer have been found to be extremely useful to the managers of financial services teams. Such items as the speed of response and time for completion of the process have been collected and found to be extremely interesting to actual professionals in financial service industries. Such statistics may be provided to members of a financial services team by numerous methods and in numerous formats.

### Summary in Reference to Claims

It is therefore an aspect, advantage, objective and embodiment of the present invention to provide a financial services consumer contact management device comprising: a first computer network site oriented to consumers and offering the services of at least one team of financial service professionals; a first communication connection allowing consumers to provide to the first site at least one consumer contact for the team of financial service professionals, the consumer contact consisting of specific contact information and general financial information; a receiving module able to receive a first consumer contact, separate the specific contact information and the general financial information of the first consumer contact, and forward the general financial information to the team of financial service professionals; a second communication connection allowing the team of financial service professionals to provide to the first site a response to the forwarding of the first consumer contact; a monitoring module able to receive the response, and forward the specific contact information to the team of financial professionals; and a professional management module able to maintain a database of contact statistics.

It is therefore yet another aspect, advantage, objective and embodiment of the present invention to provide a device wherein such database of contact statistics further comprises data selected from the group consisting of: number of contacts viewed, percentage of contacts viewed, number of offers sent, percentage of total contacts to which offers have been sent, number of consumer responses, percentage of offers which received consumer responses, percentage of offers accepted, percentage of offers declined, number of offers accepted, number of offers declined, statistical time to view contact, statistical time for response to contact, statistical time for consumer review of offer, statistical time for consumer response to offer, statistical response time, statistical time for entire process, number of requests for additional information, percentage of responses leading to requests for additional information, number of contacts converted to actual loan applications, percentage of contacts converted to actual loan applications, number of actual closings, percentage of contacts converted to actual closings, and combinations thereof.

It is therefore yet another aspect, advantage, objective and embodiment of the present invention to provide a device wherein such statistical time further comprises one member selected from the group consisting of: average times, mode times, median times, maximum times, minimum times, standard deviations of times.

It is therefore yet another aspect, advantage, objective and embodiment of the present invention to provide a device wherein such team of financial services professionals further comprises one member selected from the group consisting of: a single individual, a plurality of financial services professionals grouped under a single leader, financial services professionals located in a single office, financial services professionals belonging to a single company, and combinations thereof.

It is therefore yet another aspect, advantage, objective and embodiment of the present invention to provide a device wherein such database of contact statistics allow collection of comparative statistics between teams.

It is therefore yet another aspect, advantage, objective and embodiment of the present invention to provide a device wherein such comparative statistics between teams further comprise: comparative statistics for a single contact.

It is therefore yet another aspect, advantage, objective and embodiment of the present invention to provide a device wherein such comparative statistics between teams further comprise: comparative statistics for a plurality of contacts.

It is therefore yet another aspect, advantage, objective and embodiment of the present invention to provide a device, further comprising: a statistical reporting module providing such database of statistical data to at least one team.

It is therefore yet another aspect, advantage, objective and embodiment of the present invention to provide a device wherein such statistical reporting module provides only blind information to the at least one team.

It is therefore yet another aspect, advantage, objective and embodiment of the present invention to provide a method for financial service professional teams to manage consumer contacts, comprising the steps of: a) offering a first computer network site offering the services of at least one such financial professional team to consumers, such site offering consumers the ability to generate at least one consumer contact for such financial service professionals; b) receiving the consumer contact from such a consumer on behalf of the financial service professional team, the consumer contact comprising both specific contact information and general financial inquiry information; c) separating the specific contact information from the general financial inquiry information; d) forwarding to such financial service professional team the general financial inquiry information; e) awaiting a confirmation that such financial service professional team has responded to such consumer contact; and f) after the confirmation, forwarding to such financial service professional team the specific contact information; and g) maintaining a database of contact statistics.

It is therefore yet another aspect, advantage, objective and embodiment of the present invention to provide a method wherein the step e) of awaiting a confirmation that such financial service professional has responded to such contact further comprises: e1) providing to such financial service professional the ability to respond to such contact; e2) receiving from such financial service professional such response; and e3) forwarding such response to the consumer.

It is therefore a first aspect, advantage, objective and embodiment of the present invention to provide a financial services consumer contact management device comprising: a first forum oriented to consumers and offering the services of at least one team of financial service professionals; a first communication connection allowing a consumer to provide to the first forum at least one consumer contact for the team of financial service professionals, the consumer contact consisting of specific contact information and general financial information; a receiving module able to receive the first consumer contact, separate the specific contact information and the general financial information of the first consumer contact, and forward the general financial information to the team of financial service professionals; a second communication connection allowing the team of financial service professionals to provide to the first forum a response to the forwarding of the first consumer contact; a monitoring module able to receive the response, and forward the specific contact information to the team of financial professionals; a professional management module able to maintain a database of accurate contact management statistics; and a statistical reporting module providing such database of statistical data to the team.

It is therefore yet another aspect, advantage, objective and embodiment of the present invention to provide a financial services consumer contact management device wherein the first forum further comprises a computer network; and wherein the first and second communications connections further comprise electronic messages.

It is therefore yet another aspect, advantage, objective and embodiment of the present invention to provide a financial services consumer contact management device wherein the database of accurate contact management statistics provided to the team of financial services professionals further comprises data selected from the group consisting of: indication of whether a particular consumer contact has been viewed, indication of whether a response to a particular contact has occurred, time of a consumer contact, time of the response to a consumer contact, time from a consumer contact to viewing of that consumer contact, time from a consumer contact to response to that consumer contact, and combinations thereof.

It is therefore yet another aspect, advantage, objective and embodiment of the present invention to provide a device wherein the database of accurate contact management statistics provided to the team of financial services professionals further comprises data selected from the group consisting of: number of contacts viewed, percentage of contacts viewed, number of offers sent, percentage of total contacts to which offers have been sent, number of consumer responses, percentage of offers which received consumer responses, percentage of offers accepted, percentage of offers declined, number of offers accepted, number of offers declined, statistical time to view contact, statistical time for response to contact, statistical time for consumer review of offer, statistical time for consumer response to offer, statistical response time, statistical time for entire process, number of requests for additional information, percentage of responses leading to requests for additional information, number of contacts converted to actual loan applications, percentage of contacts converted to actual loan applications, number of actual closings, percentage of contacts converted to actual closings, and combinations thereof.

It is therefore yet another aspect, advantage, objective and embodiment of the present invention to provide a device wherein the statistical time further comprises one member selected from the group consisting of: average times, mode times, median times, maximum times, minimum times, standard deviations of times.

It is therefore yet another aspect, advantage, objective and embodiment of the present invention to provide a device wherein the team of financial services professionals further comprises one member selected from the group consisting of: a single company, a single individual, a plurality of financial services professionals grouped under a single leader, financial services professionals located in a single office, financial services professionals belonging to a more than one company, and combinations thereof.

It is therefore yet another aspect, advantage, objective and embodiment of the present invention to provide a device wherein such database of contact statistics allow collection of comparative statistics between teams.

It is therefore yet another aspect, advantage, objective and embodiment of the present invention to provide a device wherein such comparative statistics between teams further comprise: comparative statistics for a single contact.

It is therefore yet another aspect, advantage, objective and embodiment of the present invention to provide a device wherein such comparative statistics between teams further comprise: comparative statistics for a plurality of contacts.

It is therefore yet another aspect, advantage, objective and embodiment of the present invention to provide a device wherein such statistical reporting module provides only blind information to the team.

It is therefore yet another aspect, advantage, objective and embodiment of the present invention to provide a method for financial service professional teams to manage consumer contacts, comprising the steps of: a) offering a first forum offering the services of at least one such financial professional team to consumers, such forum offering consumers the ability to generate at least one consumer contact for such financial service professionals; b) receiving the consumer contact from such a consumer on behalf of the financial service professional team, the consumer contact comprising both specific contact information and general financial inquiry information; c) separating the specific contact information from the general financial inquiry information; d) forwarding to such financial service professional team the general financial inquiry information; e) awaiting a confirmation that such financial service professional team has responded to such consumer contact; and f) after the confirmation, forwarding to such financial service professional team the specific contact information; g) maintaining a database of accurate contact statistics; and h) forwarding the accurate contact statistics to such financial service professional team.

It is therefore yet another aspect, advantage, objective and embodiment of the present invention to provide a method wherein the step e) of awaiting a confirmation that such financial service professional has responded to such contact further comprises: e1) providing to such financial service professional the ability to respond to such contact; e2) receiving from such financial service professional such response; and e3) forwarding such response to the consumer.

### BRIEF DESCRIPTION OF THE DRAWINGS

FIG. 1 is a block diagram of a first device in which the present invention may be used.

FIG. 2 is a block diagram of a PRIOR ART unmediated financial connection, showing the difficulty of establishing any statistical basis for tracking and analysis of agent responses to contacts.

FIG. 3 is a flow chart of a method in which the present invention may be used.

FIG. 4 is a depiction of a first statistical report according to a first alternative embodiment of the present invention.

FIG. 5 is a depiction of a second statistical report according to a second alternative embodiment of the present invention.

INDEX OF REFERENCE NUMERALS

| | |
|---|---|
| DEVICE | 100 |
| CONSUMER COMPUTER | 102 |
| CONSUMER ORIENTED SERVER SITE | 104 |
| FINANCIAL PROFESSIONAL COMPUTER | 106 |
| FINANCIAL PROFESSIONAL SERVER SITE | 108 |
| NETWORK | 110 |
| CONSUMER CONNECTION TO NETWORK | 112 |
| PROFESSIONAL CONNECTION | 114 |
| FINANCIAL PRO SERVER CONNECTION | 116 |
| SERVER TO SERVER CONNECTION | 120 |
| PRIOR ART UNMEDIATED FINANCIAL | 201 |
| CONNECTION | |
| CONSUMER COMPUTER | 202 |
| FINANCIAL PROFESSIONAL | 206a |
| INTERNET | 210 |
| CONSUMER CONNECTION TO NETWORK | 212 |
| PROFESSIONAL CONNECTION TO NETWORK | 214 |
| METHOD | 300 |
| START | 330 |
| CONSUMER INQUIRY | 332 |
| SEPARATE STORAGE OF | 334 |
| CONTACT AND FINANCIAL DATA | |
| FORWARD FINANCIAL DATA TO | 336 |
| FINANCIAL PROFESSIONAL | |
| WAIT | 338 |
| FINANCIAL PRO RESPONSE CHECK | 340 |
| FORWARD RESPONSE TO CONSUMER | 342 |
| FORWARD CONTACT INFORMATION TO | 344 |
| FINANCIAL PROFESSIONAL | |
| TERMINATE | 346 |
| STATISTICAL REPORT | 400 |
| TITLE | 402 |
| INDEX LINE | 404 |
| CHART | 406 |
| STATUS INDICATOR | 408 |
| AGENT NAME | 410 |
| TOTAL LEAD STATISTIC | 412 |
| OFFER SENT STATISTIC | 414 |
| CONSUMER RESPONSE STATISTIC, | |
| EXPRESSED AS NUMBER | 416 |
| EXPRESSED AS PERCENTAGE | 418 |
| OFFERS ACCEPTED STATISTIC, | |
| EXPRESSED AS NUMBER | 420 |
| EXPRESSED AS PERCENTAGE | 422 |
| HIGH/LOW VALUE FLAGS | 423 |
| OFFERS DECLINED STATISTIC, | |
| EXPRESSED AS NUMBER | 424 |
| EXPRESSED AS PERCENTAGE | 426 |
| TOTAL INFORMATION REQUEST STATISTIC | |
| EXPRESSED AS NUMBER | 428 |
| EXPRESSED AS PERCENTAGE | 430 |
| REPORT CONTROLS | 432, 432′ |
| REPORT TIME SPAN INFORMATION | 434 |
| STATISTICAL REPORT | 500 |
| TITLE | 502 |
| INDEX LINE | 504 |
| CHART | 506 |
| STATUS INDICATOR | 508 |
| TEAM IDENTIFIER | 510 |
| TOTAL LEAD STATISTIC | 512 |
| TOTAL VIEWED STATISTIC | 550 |
| TOTAL OFFERS SENT STATISTIC | 552 |
| TOTAL CONSUMER REVIEWS STATISTIC | 554 |
| CONSUMER RESPONSE STATISTIC, | 516 |
| EXPRESSED AS NUMBER | |
| DISPATCH TIME STATISTIC, | 556 |
| EXPRESSED AS AVERAGE | |
| TIME TO VIEW LEAD STATISTIC, | 558 |
| EXPRESSED AS AVERAGE | |
| TIME TO MAKE OFFER STATISTIC, | 560 |
| EXPRESSED AS AVERAGE | |
| TIME FOR CONSUMER REVIEW STATISTIC | 562 |
| EXPRESSED AS AVERAGE | |
| TIME FOR CONSUMER RESPONSE STATISTIC | 564 |
| EXPRESSED AS AVERAGE | |
| TOTAL PROCESS TIME, | 566 |
| EXPRESSED AS AVERAGE TIME | |

### DETAILED DESCRIPTION

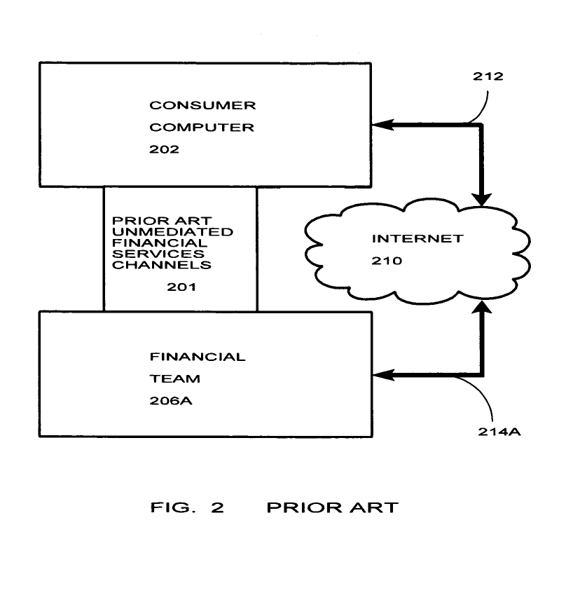

FIG. 2 is a block diagram of a PRIOR ART unmediated financial connection, showing the difficulty of establishing any statistical basis for tracking and analysis of agent responses to contacts.

In such a PRIOR ART UNMEDIATED FINANCIAL CONNECTION 201, it is normal for the consumer and agent to be placed in complete communication at the initial stage of the process, following the common sense dictum that more avenues of communication will lead to greater communication. Prior art systems which do not directly teach that in fact under certain sets of conditions, this common sense dictum may not be the most efficient method of spurring and analyzing team performance thus cannot teach towards the device and methods of the present invention. CONSUMER COMPUTER 202 and FINANCIAL PROFESSIONAL 206a are placed into a “wide” and unlimited form of communication almost immediately after a consumer initiates a contact to the financial services team, for example via INTERNET 210, which may have a financial services website offering comparative quotes or some similar entre to unlimited and unmediated communications between consumer computer 202 and financial professional 206a, by unregulated methods including E-mail, telephone, regular mail, facsimile, and so on. CONSUMER CONNECTION TO NETWORK 212 and PROFESSIONAL CONNECTION TO NETWORK 214 may as well function as a direct link 201 from the initiation stage.

The crucial and uncontrolled predecessor step to action in such prior art systems is the act of “viewing” the consumer contact. Viewing the contact in general may include examining the data entered on an Internet form by the consumer, reading an E-mail sent by the consumer, pulling credit information, examining whatever documentation is provided, listening to an audio contact and other ways of initially assessing the consumer contact. This step of viewing the contact then allows a response to be generated.

In theory, such prior art systems allow the possibility to collect at least certain statistics from the consumers. Furthermore (in theory) it should be possible to time stamp the times of such activities by consumers and team members. For example, in some prior art systems, the professional response may be subject to externally imposed requirements that the response be documented to the prior art system. Such externally imposed requirements may take the form of voluntary reporting, company/team regulations to the effect that all times must be logged manually or by electronic methods, continuous monitoring of the team members by supervisors and so on. The applicant is unaware of any prior art which INTERNALLY requires a response by withholding the desired contact information until the response is generated and thus allows absolutely accurate time-stamping of contacts, viewing of contacts, responses and so on, and in culmination of the process allows creation of accurate statistics regarding response times. The collection of the “core group” (see below and claim 3) of statistics of the present invention are thus predicated upon the separation of contact information from the information necessary for the response. However, such voluntary statistics are notoriously unreliable: the financial professionals most aggressive about pursuing new leads may be the same individuals least likely to promptly document responses or document them at all. For example, in one case actually on the market, a statistic called “hours to response” is provided. In practice, most such responses are listed as “zero” hours. The problem is that this statistical measure is not accurately collected. Firstly, the zero indicator may mean either that no response has been sent or that the response occurred in under one hour. Secondly, the actual response may flow by means of a channel outside of the control of the prior art system, and may not be documented accurately or at all, so the value of the statistic is effectively reduced to zero.

Finally, such systems do not have modules which can report the statistics to the users, thus there is no inherent value to such statistics to the prior art system managers.

The present invention prevents unmediated information flow at the initial stage of communications, thus effectively spurring greater promptitude and accuracy of response by such financial teams and team members.

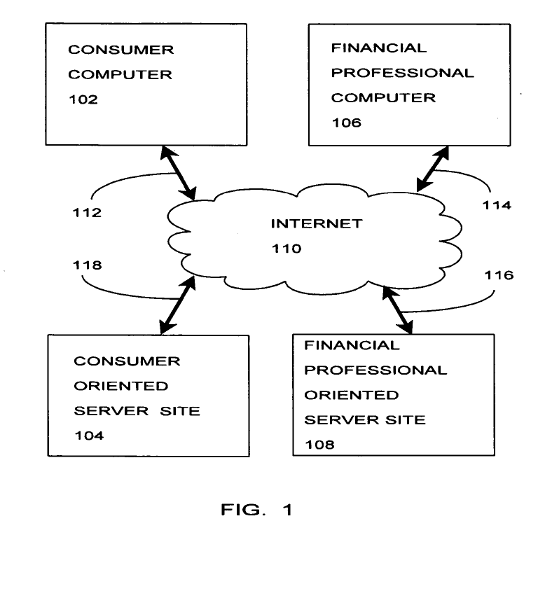

FIG. 1 is a block diagram of a first device in which embodiments of the present invention may be used. DEVICE 100 links CONSUMER COMPUTER 102 with CONSUMER ORIENTED SERVER SITE 104. FINANCIAL PROFESSIONAL COMPUTER 106 is linked to FINANCIAL PROFESSIONAL SERVER SITE 108. Both linkages occur via NETWORK 110, which in the preferred embodiments is the Internet. In other embodiments, other computer networks may be utilized. CONSUMER CONNECTION TO NETWORK 112, PROFESSIONAL CONNECTION 114, FINANCIAL PRO SERVER CONNECTION 116, and CONSUMER SERVER CONNECTION 120 may be effectuated by any of a variety of methods. In a case in which network 110 is the Internet, such connections may be dial-up, cable, DSL, T1, wireless, etc, and may be provided through an ISP or other conventional methods.

Servers/Sites 104 and 108 may be one or more websites offered by means of the Internet (as in the best mode now contemplated), or may be another type of computer provided intermediary. In general, the important component is a central computer system which provides communications links between consumers and professionals, which offers/advertises financial services to consumers, and which stores and forwards information according to the present device. Thus, this may be a central computer system, a single website, a pair of websites, a dedicated network in hardware or software, etc. Servers/Sites 108 and 104 may be combined into a single entity which provides differential access to professionals versus consumers. Thus two websites or one may be offered, or two servers or one may be utilized.

When more than one such entity is used (as shown in FIG. 1), then SERVER TO SERVER CONNECTION 120 may provide a connection from sites/servers 104 and 108. In the presently preferred embodiment and best mode presently contemplated for carrying out the invention, the need for connection 120 is obviated by making the site to site connection (104 to 108) be means of the Internet. Thus, in embodiments connection 120 may or may not be necessary or desirable even in cases in which two or more central computer systems/servers/sites are utilized.

Consumer computer 102 is used to access the information provided at consumer oriented server site 104. In one embodiment, this information may be comparative statistics regarding financial services offered by different lenders, banks, mortgage brokers, investment bankers and brokers, and so on. Side by side comparison of details of such offers has proven beneficial to the consumer. Thereafter, the consumer may initiate a consumer contact with selected financial professionals. Such contacts may also be initiated automatically by consumer usage of features of site 104, for example, by the consumer electing to examine a repayment schedule for a given mortgage at a given percentage rate and time.

The communication connections provided to consumers and professional financial teams may be E-mail, telephone, facsimile, short message service (text message) (SMS), mail, Internet postings, a web page form, computer chat and combinations thereof. For example, the consumer may be asked to fill out a form on-line, providing information in blanks on a web page. This information may then be submitted to the central computer.

One important module of the present device is a receiving module able to receive such consumer contacts as an intermediary between the consumer and the professional or professional team. The module will separate the specific contact information from the general financial information and forward only the general financial inquiry information to the financial service team.

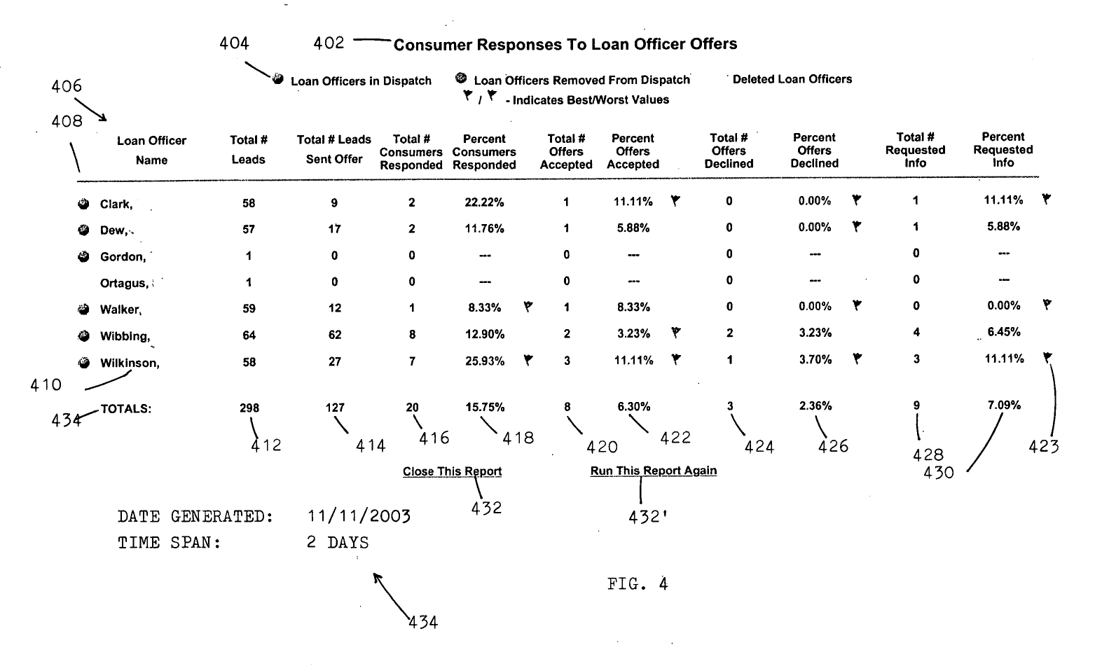

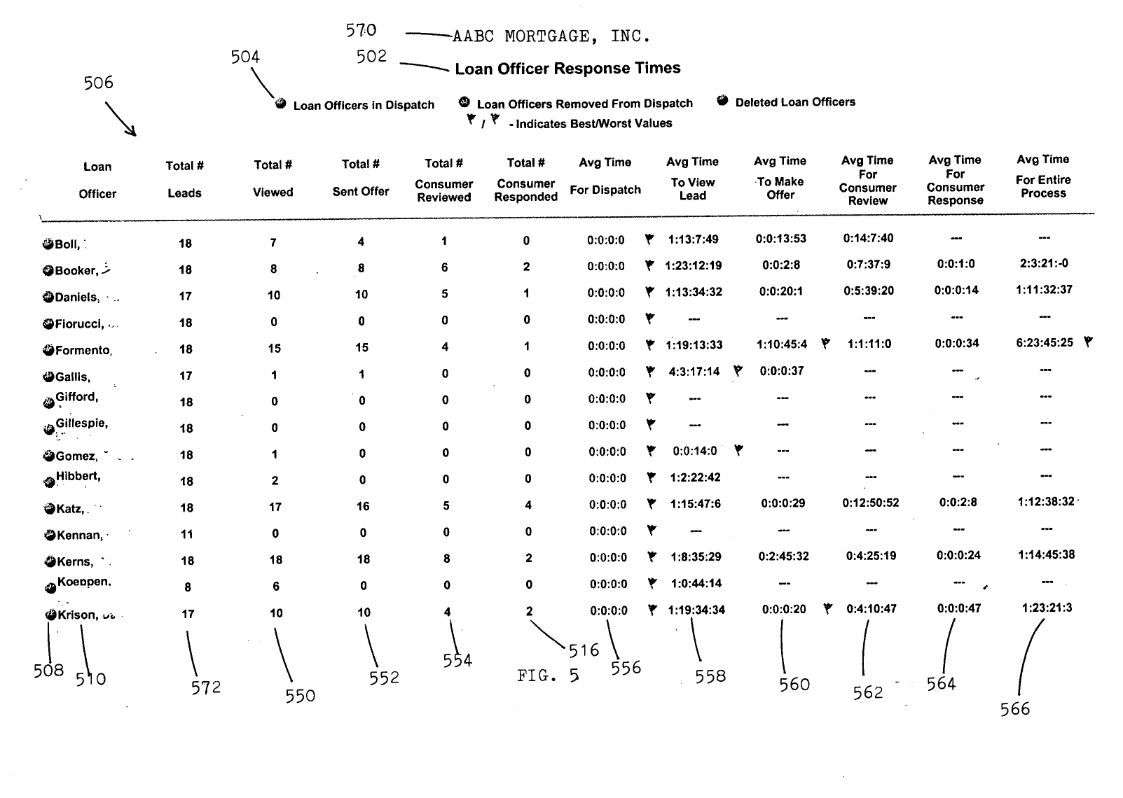

The financial service team will also have a connection, which may be the same or a different type, for communicating a response to the consumer. Since the team has received no specific contact information, the intermediary site(s) are necessary for this return communication. In one preferred embodiment, the consumer may use a web form or E-mail for the first communication connection, but the professional will actually have a choice of types of communication connections, so that the use of the device by the professional may be customized to suit their own needs. As will be explained in more detail in regard to FIGS. 4 and 5, the knowledge that statistical analysis of response time and effectiveness is being conducted will motivate the team to speedier and more effective response to such contacts.

Device 100 may also comprise a monitoring module able to monitor the financial professional for a response to the consumer contact. In the presently preferred embodiment, this may take the form of server/site/central computer system 108: the team member would log onto this server and use it to send a message to the consumer. The device 100 (acting again as intermediary) will retain the specific contact information needed to allow this response to be forwarded to the consumer, as this information has not yet been provided to the financial team. Only after the financial services team has carried out the response will such specific contact information be forward the specific contact information to the financial professional or financial team member. In alternative embodiments, other structures may be used by which the team/member does not receive such specific contact information until completion of some type of response to the contact. In yet further embodiments, the professional team/member response may not be an actual communication with the consumer but may take the form of a “book-keeping” step allowing monitoring of overall professional activities.

It will be seen that this mediation of the process in turn allows collection of real, true and accurate statistics on contact management.

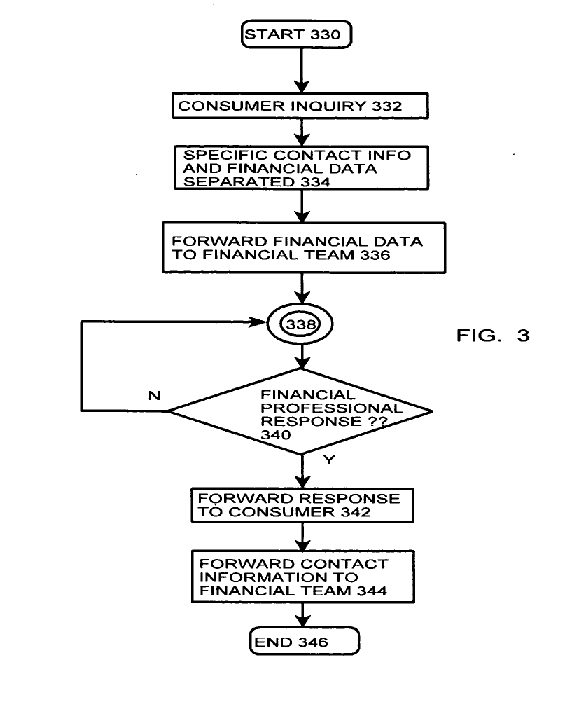

FIG. 3 is a flow chart of a third method embodiment of the present invention. At the start step 330, a consumer makes an inquiry 332 to the team. The inquiry may contain both specific contact information and general financial inquiry information. At step 334, the two types of data are separated, they may also be stored in a storage medium of the types now know or later developed: magnetic media, optical media, etc. At step 336, the general financial inquiry data is forwarded to the professional. Step 338 represents a wait state: until the condition of step 340 is satisfied, no further activities are undertaken: the system is awaiting a confirmation that such financial service professional team/member has responded to the consumer contact. Note that “response” in this case could include two meanings: both a communication response to that consumer, or it could include a “reaction” involving some other action taken. Examples of possible responses thus include return messages to the consumer, beginning some other communication step (such as dialing the consumer “blind” by means of a telephone exchange which dials the consumer without the team member being given the telephone number), beginning an in-team process such as opening a file, alerting a supervisor, transferring the matter to another team or another team member, and other potential reaction/responses to the contact. At step 342 the response is forwarded to the consumer (by means of the specific contact information) and at step 344 the specific contact information is forwarded to the team. Operations may terminate at step 346 in the preferred embodiment.

The wait at steps 338, 340 may comprise an internal flag, initiation of a response module by the professional response to the consumer, etc, and it may be ended by receipt of any type of communication.

The system may also provide to such financial service professional the ability to respond to such contact, for example, by means of a web form in the originally forwarded message, thus greatly easing the burden on the professional to make the response. Other such abilities may be offered to the professional by the service: ability to respond by fax, voice, SMS, E-mail, etc. The system of course is also capable of receiving from such financial service professional such response; and forwarding such response to the consumer. The important point is that the system is not unmediated: such alternative types of communications are only provided after the professional team or team member has initiated a response via the system, thus allowing monitoring and statistical analysis of the process.

One such alternative embodiment involves use of an automated dialing system. The financial professional team uses the dialing system and enters a contact identification which indicates to the dialing system which of a number of potential contacts is desired, after which the dialing system completes the call. By this means, a response may be initiated in a “person to person” telephone call, yet the financial services team is forced to make such a response in order to garner the desired contact information for the individual seeking the services. This embodiment still allows collection of the desired statistics.

It will be seen that the present invention may be embodied in a number of such alternative devices in addition to computer networks and telephone autodialers. It may be implemented by a wide variety of such physical embodiments of the invention.

While the presently preferred embodiment is a computer network such as the Internet or websites thereon, it will be appreciated that it may be implemented in any broad “forum” in which consumers and financial services professionals (for example, mortgage lenders) meet or exchange information in order to begin business negotiations. Such a forum may be a voice mail system offering audible information to consumers and/or professional teams, it may be a website or computer network, publications of all types and in all physical formats and other similar forums.

As a parallel or sequential process to the process outlined above, the system may maintain a database of contact statistics.

An additional professional management module may be used to monitor contacts and maintain a database of contact statistics. In particular, it will be appreciated that professional performance in responding to consumer contacts is of great importance in any financial service business.

Such professional performance breaks down into at least two broad categories including time of response and success of response. Other broad types of statistical information may be sought using the device and methods of the present invention, and within these broad categories, varies items of information may be sought. It will be appreciated that such information can be rendered or expressed in a number of statistical forms. The raw numbers may be desirable under certain circumstances, while under other conditions, percentages, time spans, averages (means), medians, modal values, highs, lows and the identification of outstanding teams and team members may be of interest.

Yet another method of breaking down such information constitutes the designation of teams of financial services professionals. The team concept may be applied at a number of levels with varying benefits. Teams may consist of a single company, a single individual, a plurality of financial services professionals grouped under a single leader, financial services professionals located in a single office, financial services professionals belonging to a single company, and combinations thereof.

Most importantly, the single company as team embodiment allows companies which use the device of the present invention to monitor their own internal contact management and compare it to averages of other companies/teams or to specified other teams in the industry.

Comparisons between single individuals are fairly straightforward in concept and benefit: some individuals are better sales people than others, individuals have varying work habits and so on. The internal comparison of a team as single company is also of clear benefit to all concerned. A group of professionals under a single leader, however, may be used to determine what portions of a financial services organization are performing at highest efficiency, thus allowing the internal determination of those factors contributing to lower efficiency and the removal of such obstacles. It may also allow the determination of which team leaders allow their team members to function at highest individual efficiency, for example, by comparison between the team under individual “A” with the team under individual “B”. Teams designated as being located in a single office may reveal regional or operational differences with teams in different offices which may increase efficiency in one or both offices. For example, if the office in city “C” consistently outperforms the office in city “D”, it would allow intelligent examination of the potential reasons therefore.

(For purposes of this application, such “internal” comparisons refer to comparisons within the company or team, while “external” comparisons refer to comparisons to other teams or companies.)

External (cross company) comparisons might be very beneficial. Not only would such information be of extreme value to potential investors and potential clients, but it could also be used as a motivational tool directed between companies. Several methods present themselves for such operations, one or more of which may be implemented as “blind” comparisons in which the receiver of the statistical information does not know the identity of the competing company. Response times, success ratios in proceeding to various steps and other statistics of individual teams or team members could be compared between companies, either by name, by company identification, or by statistical sample, or blind. Particularly when specific identification if provided, this could be of high value: “Team “E” of company “F” gets their responses out in an average of under seven minutes and their offer acceptance ratio is higher than that of team “G” of company “H” by 22%”. Even when blind information is provided “Some other companies team got their response out in an average 3.5 minutes” it could be helpful.

In another embodiment, such statistics may be offered based upon individual consumers, thus converting the financial service process into a race in which the competitors are instantly aware of their relative time of response and the success and failure standings which often flow directly therefrom.

It is worthwhile to note that dynamic definition of teams may be utilized, in which a smallest professional unit, for example, a single office or single individual, may be defined, and then the statistics collated in real time at the time of report generation on the basis of dynamic team definitions of a number of such units. Thus, a “team” might defined, for certain statistical purposes, which consists not of a single company nor a single office in a single company but rather of every financial services professional in a given geographical area, regardless of the normally defined “teams” (such as various companies) to which those individuals putatively belong.

As stated earlier, in a large organization with more than one team of mortgage brokers, lenders, or other financial professionals, there may be certain individuals and teams who are relatively efficient about answering their E-mail or other contacts from consumers and others who are relatively less efficient. Tracking the performance of the group as a whole, and the individuals within the group, is thus a high priority to the organization or group. The present invention allows this tracking by means of a management module.

The module may collect statistical information regarding contact demographics such as geographic location, age, income, employment, may retain information regarding contact methods such as E-mail versus text message, method of offering services responded to by the consumer (website, advertising, telephone, etc), contact financial information such as loan type (i.e. purchase, refinance, home equity, etc), credit history, specific contact information as discussed above, response content from the professional, and very importantly: response time, financial service professional identity and combinations thereof. Response time by a given professional allows easy management of the group of professionals and thus increased efficiency of the overall operation.

There is a first “core group” of statistical information, presented herein at the unit level, which may be collected by means of the present invention. It is believed by applicant that collection of this information is unique to the present method, since the prior art does not allow any accurate tracking of responses, due in turn to the fact that the prior art does not separate consumer contact information and withhold it until a satisfactory response has been generated by the team/team member. Thus the database of accurate contact management statistics provided to the team of financial services professionals may comprise a “core group” of data selected from the group consisting of: indication of whether a particular consumer contact has been viewed, indication of whether a response to a particular contact has occurred, time of a consumer contact, time of the response to a consumer contact, time from a consumer contact to viewing of that consumer contact, time from a consumer contact to response to that consumer contact, and combinations thereof.

More in depth statistical information may be gathered and disseminated. Such information may include in a reasonably exemplary listing: number of contacts viewed, percentage of contacts viewed, number of offers sent, percentage of total contacts to which offers have been sent, number of consumer responses, percentage of offers which received consumer responses, percentage of offers accepted, percentage of offers declined, number of offers accepted, number of offers declined, statistical time to view contact or contacts, statistical time for response to contact or contacts, statistical time for consumer review of offer or offers, statistical time for consumer response to offer or offers, statistical response time, statistical time for entire process, number of requests for additional information, percentage of responses leading to requests for additional information, number of contacts converted to actual loan applications, percentage of contacts converted to actual loan applications, number of actual closings, percentage of contacts converted to actual closings, and naturally combinations thereof. As noted, average times, mode times, median times, maximum times, minimum times, standard deviations of times, high and low values, percentages, raw numbers and time spans may be used.

A statistical reporting module may provide abstracts and reports, or raw data, from such database of statistical information to such teams. This module may be tailored so as to allow only access in the ways desired by the system administrator of the invention, thus, the data provided may be “blind” (that is, complete but with team identification deleted, for example, between teams in different companies), may be provided only as broad statistics, or may be entirely open. Access to such statistical reporting module may also depend upon the degree of authorization which a given team or supervisor is permitted, whether by contractual relationship with the system administrator of the invention, by permission within a given company, team or organization, or on another basis.

Such statistical reporting module may occur in real-time processing mode, such that the statistics are generated at the time the request is made by a supervisor. In other embodiments, not as favored, the statistics may be generated only at a given time interval such as quarterly, monthly, daily and the like. It would preferable, however, to provide regular reports regardless of user requests, and in addition to allow real-time reporting when requested.

Such reports may be generated on paper or on screen, in a server-client relationship in which the server generates such reports, by means of a module using a client-side database which is frequently updated and so on. Such reports may also be audible: in certain embodiments, a supervisor may telephone the supervisory module in order to obtain specified information by telephone. Facsimile, E-mail, SMS and other formats may be substituted as well.

FIG. 4 is a depiction of a first statistical report according to a first alternative embodiment of the present invention. STATISTICAL REPORT 400 includes TITLE 402 and INDEX LINE 404 as headings to the main CHART 406 on which such statistical information is tabulated. REPORT CONTROLS 432, 432′ provide control over how the report is formatted, set up, viewed, filed and other standard file control and spreadsheet functions as may be desired for the purposes of the alternative embodiment used. REPORT TIME SPAN INFORMATION 434 places the report into context in terms of time, while other contextual information in other embodiments may specify the teams being compared, what statistical bases are being used, and so on.

In this embodiment, the individual team is a single person and is thus identified by name. STATUS INDICATOR 408 and AGENT NAME 410 identify this person and their work status.

TOTAL LEAD STATISTIC 412 may identify the total number of contacts forwarded to the agent, OFFER SENT STATISTIC 414 identifying the offers sent by that individual in response to such leads. CONSUMER RESPONSE STATISTIC, EXPRESSED AS NUMBER 416 or EXPRESSED AS PERCENTAGE 418 can assist in determining how efficient the individual was at sending offers consumers responded to. OFFERS ACCEPTED STATISTIC, EXPRESSED AS NUMBER 420 or EXPRESSED AS PERCENTAGE 422 depending upon circumstances, provides a detailed look at how effective the agent (or team, in alternative embodiments) was at providing an offer consumers agreed to accept.

These last two statistical measures, compared, might show that a team or firm had an excellent ability to provoke consumer interest but could not make competitive offers, or the opposite. Thus lateral comparisons of statistics within a single team are also possible, thus allowing analysis of what aspects of an organization's or individual's financial service operations are most effective and which aspects are least effective.

HIGH/LOW VALUE FLAGS 423 may also allow an easy indication of what is working and what is not, either laterally (within a process) or competitively (between teams). Such flags may also serve as warning signs drawing the attention of supervisors to problem areas, such as agent or team which has suddenly dropped to a zero rate of responses to leads, thus possibly indicating that the team in question has lost it's connection to the network, is having other difficulties and so on.

OFFERS DECLINED STATISTIC, either EXPRESSED AS a NUMBER 424 or EXPRESSED AS PERCENTAGE 426 is the negative framing of the offers accepted statistic, which may aid clarity or may be used for other purposes.

TOTAL INFORMATION REQUEST STATISTIC (EXPRESSED AS NUMBER 428 or PERCENTAGE 430) is yet another indicator: how many consumers requested further information? This indicates that the device and method of the present invention may advantageously be used to control not just a single aspect or stage of communications but may be used to gather intermediate statistical data as well.

FIG. 5 is a depiction of a second statistical report according to a second alternative embodiment of the present invention. STATISTICAL REPORT 500 has TITLE 502 and INDEX LINE 504 preceding CHART 506. STATUS INDICATOR 508 for each team tells the status of that team. Particularly in the Internet era, a team may well operate in the “on-line” mode in which team members essentially work on the computer in the lead generation and financial service provision stage of operations.

TEAM IDENTIFIER 510 identifies a team by the name of the team leader under which the financial services professionals of the team are grouped. Such team identifier may also be an alpha-numeric identifier such as “TEAM 12A” or “RED TEAM”, or it may be by location “DENVER”, branch “RESIDENTIAL DIVISION”, by company “ABC LOAN SERVICES OF OAKLAND” and so on.

TOTAL LEAD STATISTIC 512 is as previously discussed, while TOTAL VIEWED STATISTIC 550 provides insight into how many contacts may be waiting for professional review and thus sitting idle wasting time.

TOTAL OFFERS SENT STATISTIC 552 may indicate the number of offers sent to consumers by the team, TOTAL CONSUMER REVIEWS STATISTIC 554 would show how many of such offers have been reviewed by the consumer. This may be easily implemented by having the consumer use a website intermediary of the invention, by use of an “E-mail receipt request” feature such as is now standard in E-mail systems, by manual entry etc.

CONSUMER RESPONSE STATISTIC either EXPRESSED AS NUMBER 516 or otherwise details consumer interest and response to the offers. This may be a combined statistic, as others may be: it may be derived from other information gleaned, by summation (for example of the response by accepting offers and a response by requesting more information), or it may another benchmark of consumer response.

DISPATCH TIME STATISTIC, EXPRESSED AS AVERAGE 556, or expressed otherwise (for example in the case of a single instance or by means of mode, median, etc) may indicate the system efficiency. An automated lead/contact dispatch module, or a supervisory function, may thus be analyzed to determine not just team efficiency but also system efficiency. Other similar statistics may show the effectiveness of the system of the invention rather than the effectiveness of the individual teams, and thus may provide yet another type of statistic which may be gathered by the method and device of the invention.

TIME TO VIEW LEAD STATISTIC, EXPRESSED AS AVERAGE 558 (though not necessarily so limited, as other statistics herein) may indicate how quickly different teams view their leads.

TIME TO MAKE OFFER STATISTIC, EXPRESSED AS AVERAGE 560, can be used to determine how long from viewing to response a team takes in its work cycle, thus indicating if a problem or inefficiency exists at this stage of operations.

TIME FOR CONSUMER REVIEW STATISTIC EXPRESSED AS AVERAGE 562, and TIME FOR CONSUMER RESPONSE STATISTIC EXPRESSED AS AVERAGE 564 provide valuable (and self explanatory) statistical information which is based upon consumer performance. By permitting gathering (“data mining”) of such statistics, the present invention may allow the implementation of further commercial practices such as market segmentation, targeted marketing, and so on.

TOTAL PROCESS TIME, EXPRESSED AS AVERAGE TIME 566 may be another derived statistic, and may indicate that a team having what appear to be problems in one area (for example, a slow TIME TO MAKE OFFER such as 560) might in fact be more effective overall.

In the method embodiment of the present invention, the consumer is offered a website or other central location offering the services of the financial professional and offers consumers the ability to generate a consumer contact to the professional.

The steps in such a method embodiment may comprise the following:

a) offering a first computer network site offering the services of at least one such financial professional team to consumers, such site offering consumers the ability to generate at least one consumer contact for such financial service professionals;

b) receiving the consumer contact from such a consumer on behalf of the financial service professional team, the consumer contact comprising both specific contact information and general financial inquiry information;

c) separating the specific contact information from the general financial inquiry information;

d) forwarding to such financial service professional team the general financial inquiry information;

e) awaiting a confirmation that such financial service professional team has responded to such consumer contact by:

e1) providing to such financial service professional the ability to respond to such contact;

e2) receiving from such financial service professional such response; and

e3) forwarding such response to the consumer

f) after the confirmation, forwarding to such financial service professional team the specific contact information;

g) maintaining a database of contact statistics; and

h) forwarding such contact statistics to such financial service professional team.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

1. A financial services consumer contact management device comprising:
a first forum oriented to consumers and offering the services of at least one team of financial service professionals;
a first communication connection allowing a consumer to provide to the first forum at least one consumer contact for the team of financial service professionals, the consumer contact consisting of specific contact information and general financial information;
a receiving module able to receive the first consumer contact, separate the specific contact information and the general financial information of the first consumer contact, and forward the general financial information to the team of financial service professionals;
a second communication connection allowing the team of financial service professionals to provide to the first forum a response to the forwarding of the first consumer contact;
a monitoring module able to receive the response, and forward the specific contact information to the team of financial professionals;
a professional management module able to maintain a database of accurate contact management statistics; and
a statistical reporting module providing such database of statistical data to the team.

2. The financial services consumer contact management device of claim 1, wherein the first forum further comprises a computer network; and wherein the first and second communications connections further comprise electronic messages.

3. The device of claim 1, wherein the database of accurate contact management statistics provided to the team of financial services professionals further comprises data selected from the group consisting of: indication of whether a particular consumer contact has been viewed, indication of whether a response to a particular contact has occurred, time of a consumer contact, time of the response to a consumer contact, time from a consumer contact to viewing of that consumer contact, time from a consumer contact to response to that consumer contact, and combinations thereof.

4. The device of claim 1, wherein the database of accurate contact management statistics provided to the team of financial services professionals further comprises data selected from the group consisting of: number of contacts viewed, percentage of contacts viewed, number of offers sent, percentage of total contacts to which offers have been sent, number of consumer responses, percentage of offers which received consumer responses, percentage of offers accepted, percentage of offers declined, number of offers accepted, number of offers declined, statistical time to view contact, statistical time for response to contact, statistical time for consumer review of offer, statistical time for consumer response to offer, statistical response time, statistical time for entire process, number of requests for additional information, percentage of responses leading to requests for additional information, number of contacts converted to actual loan applications, percentage of contacts converted to actual loan applications, number of actual closings, percentage of contacts converted to actual closings, and combinations thereof.

5. The device of claim 4, wherein the statistical time further comprises one member selected from the group consisting of: average times, mode times, median times, maximum times, minimum times, standard deviations of times.

6. The device of claim 4, wherein the team of financial services professionals further comprises one member selected from the group consisting of: a single company, a single individual, a plurality of financial services professionals grouped under a single leader, financial services professionals located in a single office, financial services professionals belonging to a more than one company, and combinations thereof.

7. The device of claim 1, wherein such database of contact statistics allow collection of comparative statistics between teams.

8. The device of claim 7, wherein such comparative statistics between teams further comprise: comparative statistics for a single consumer contact.

9. The device of claim 7, wherein such comparative statistics between teams further comprise: comparative statistics for a plurality of consumer contacts.

10. The device of claim 1, wherein such statistical reporting module provides only blind information to the team.

11. A method for financial service professional teams to manage consumer contacts, comprising the steps of:
a) offering a first forum offering the services of at least one such financial professional team to consumers, such forum offering consumers the ability to generate at least one consumer contact for such financial service professionals;
b) receiving the consumer contact from such a consumer on behalf of the financial service professional team, the consumer contact comprising both specific contact information and general financial inquiry information;
c) separating the specific contact information from the general financial inquiry information;
d) forwarding to such financial service professional team the general financial inquiry information;
e) awaiting a confirmation that such financial service professional team has responded to such consumer contact; and
f) after the confirmation, forwarding to such financial service professional team the specific contact information;
g) maintaining a database of accurate contact statistics; and
h) forwarding the accurate contact statistics to such financial service professional team.

12. The method of step 11, wherein the step e) of awaiting a confirmation that such financial service professional has responded to such contact further comprises:
e1) providing to such financial service professional the ability to respond to such contact;
e2) receiving from such financial service professional such response; and
e3) forwarding such response to the consumer.
